(19) United States
(12) Patent Application Publication
(10) Pub. No.: US 2022/0187448 A1
(43) Pub. Date: Jun. 16, 2022

(54) Adjusting Lidar Parameters Based on Environmental Conditions

(71) Applicant: Waymo LLC, Mountain View, CA (US)

(72) Inventors: Mark Alexander Shand, Palo Alto, CA (US); Lucas Peeters, Palo Alto, CA (US); Rui Wu, Goleta, CA (US); Blaise Gassend, East Palo Alto, CA (US); Stephen Osborn, Redwood City, CA (US); Paul Karplus, Redwood City, CA (US); Georges Goetz, Mountain View, CA (US)

(21) Appl. No.: 17/376,611

(22) Filed: Jul. 15, 2021

Related U.S. Application Data
(60) Provisional application No. 63/126,092, filed on Dec. 16, 2020.

(51) Int. Cl. G01S 13/931; G06K 9/00; G01S 7/4861

(52) U.S. Cl. CPC G01S 13/931; G01W 1/06; G01S 7/4861; G06K 9/00791

(57) ABSTRACT

Computing devices, systems, and methods described in various embodiments herein may relate to a light detection and ranging (lidar) system. An example computing device could include a controller having at least one processor and at least one memory. The at least one processor is configured to execute program instructions stored in the at least one memory so as to carry out operations. The operations include receiving information identifying an environmental condition surrounding a vehicle, the environmental condition being at least one of fog, mist, snow, dust, or rain. The operations also include determining a range of interest within a field of view of the lidar system based on the received information. The operations also include adjusting at least one of: a return light detection time period, sampling rate, or filtering threshold, for at least a portion of the field of view based on the determined range of interest.

### CROSS-REFERENCE TO RELATED APPLICATIONS

The present disclosure claims priority to U.S. Provisional Application No. 63/126,092, filed on Dec. 16, 2020, the entire contents of which are herein incorporated by reference.

### BACKGROUND

Light detection and ranging (LIDAR or lidar) systems can be utilized to determine a distance to various objects within a given environment. For example, a light emitter subsystem of a lidar device may emit near-infrared light pulses, which may interact with objects in the device's environment. At least a portion of the light pulses may be redirected back toward the lidar (e.g., due to reflection or scattering) and detected by a detector subsystem. The distance between the lidar device and a given object may be determined based on a time of flight of the corresponding light pulses that interact with the given object.

When lidar systems are utilized to identify potential obstacles of a vehicle, it is desirable to identify unobstructed space within an exterior environment of the vehicle with a high level of confidence.

### SUMMARY

The present disclosure generally relates to light detection and ranging (lidar) systems and associated computing devices, which may be configured to obtain information about an environment. Such lidar systems and associated computing devices may be implemented in vehicles, such as autonomous and semi-autonomous automobiles, trucks, motorcycles, and other types of vehicles that can navigate and move within their respective environments.

In a first aspect, a method of operating a lidar system coupled to a vehicle is provided. The method includes receiving information identifying an environmental condition surrounding the vehicle. The method also includes determining a range of interest within a field of view of the lidar system based on the received information. The method also includes adjusting at least one return light control parameter for at least a portion of the field of view based on the determined range of interest.

In a second aspect, a computing device is provided. The computing device includes a controller having at least one processor and at least one memory. The at least one processor is configured to execute program instructions stored in the at least one memory so as to carry out operations. The operations include receiving information identifying an environmental condition surrounding a vehicle, wherein a lidar system is coupled to the vehicle. The operations also include determining a range of interest within a field of view of the lidar system based on the received information. The operations also include adjusting at least one return light control parameter for at least a portion of the field of view based on the determined range of interest.

In a third aspect, a lidar system coupled to a vehicle is provided. The lidar system includes one or more light-emitter devices configured to emit light into a field of view of the lidar system. The lidar system also includes one or more detectors configured to detect returned light. The lidar system also includes a controller having at least one processor and at least one memory. The at least one processor is configured to execute program instructions stored in the at least one memory so as to carry out operations. The operations include receiving information identifying an environmental condition surrounding the vehicle. The operations also include determining a range of interest within a field of view of the lidar system based on the received information. The operations also include adjusting at least one return light control parameter for at least a portion of the field of view based on the determined range of interest.

In a fourth aspect, a vehicle is provided. The vehicle includes a lidar system. The lidar system one or more light-emitter devices configured to emit light into a field of view of the lidar system. The lidar system also includes one or more detectors configured to detect returned light. The lidar system also includes a controller having at least one processor and at least one memory. The at least one processor is configured to execute program instructions stored in the at least one memory so as to carry out operations. The operations include receiving information identifying an environmental condition surrounding the vehicle. The operations also include determining a range of interest within a field of view of the lidar system based on the received information. The operations also include adjusting at least one return light control parameter for at least a portion of the field of view based on the determined range of interest.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1A illustrates a vehicle, according to an example embodiment.

FIG. 1B illustrates a vehicle, according to an example embodiment.

FIG. 1C illustrates a vehicle, according to an example embodiment.

FIG. 1D illustrates a vehicle, according to an example embodiment.

FIG. 1E illustrates a vehicle, according to an example embodiment.

FIG. 2 illustrates a lidar system, according to an example embodiment.

FIG. 3 illustrates example lidar system operations, according to an example embodiment.

FIG. 4 illustrates a method, according to an example embodiment.

FIG. 5 illustrates increasing a return light filtering threshold, according to an example embodiment.

FIG. 6 illustrates an example timing diagram for return light detection, according to an example embodiment.

FIG. 7 illustrates another example timing diagram for return light detection, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Systems and methods described in various embodiments herein relate to light detection and ranging (LIDAR or lidar) systems. Such systems can be utilized to determine a distance to various objects within a given environment. In some embodiments, the systems and methods described herein could be utilized in semi- or fully-autonomous vehicles, such as with self-driving cars and trucks. Additionally or alternatively, the described embodiments could be utilized in aerial drones, boats, submarines, and/or other moving vehicles or systems like robots that benefit from a map of their environment.

When lidar systems are utilized to identify potential obstacles in an autonomous mode (e.g., self-driving vehicle), it is desirable to identify instances in which an instrumented space within an environment of the lidar system can be determined to be unobstructed with a high level of confidence. In the context of the present disclosure, the terms instrumenting and instrumented refers to obtaining and subsequently processing data from the vehicle's environment using one or more sensors, sensor processors, and the like. Furthermore, as used herein, the term environment refers to an exterior environment surrounding the vehicle.

A lidar device of a lidar system can include one or more light-emitter devices and one or more detectors. Using the light-emitter device(s) and detector(s), the lidar device can obtain a sequence of scans of a field of view of a vehicle's environment. For instance, in a first scan of the sequence, the one or more light-emitter devices can emit a plurality of light pulses into the field of view during an emission time period, and then the one or more detectors can detect returned light pulses during a detection time period that follows the emission time period. At least a portion of the emitted light pulses may be redirected back toward the lidar device (e.g., due to reflection or scattering) and detected by the one or more detectors during the detection time period. Light pulses that reflect off objects that are closer to the vehicle can take less time to return to the one or more detectors, and thus the one or more detectors can detect such light pulses earlier during the detection time period. By contrast, light pulses that reflect off objects that are farther from the vehicle can take more time to return to the one or more detectors, and thus the one or more detectors can detect such light pulses later during the detection time period.

The intensity of each returned pulse can be measured by the lidar system and represented in a waveform that indicates the intensity of detected light over time. Each such waveform can be sampled during detection, where each sample represents a particular return intensity of the waveform at a particular point in time. Thus, distances to each point within the field of view (e.g., within a point cloud corresponding to the field of view), and the physical characteristics of those points (e.g., reflectivity, color, etc.), can be represented by a corresponding waveform. For example, the distance between the lidar device and a given point within the field of view can be determined based on a speed of light in air and further based on a time of flight. Thus, from this processing, the lidar system or a computer connected to the lidar can build a representation of the field of view, such as a 3D point cloud.

The present disclosure provides improved lidar systems and methods that address one or more issues that can arise in various scenarios in which lidar technology is used. Existing lidar systems can have limits in terms of the storage space, computation power, and thermal budget of their processor chips. In addition, existing lidar systems can be limited in terms of the bandwidth with which components of the lidar system exchange data between themselves and/or push data to other computational components of the vehicle (e.g., a central control system of the vehicle). Further still, existing lidar systems may only have a limited detection time period during which to detect return light.

For at least the aforementioned reasons, such existing lidar systems can only allocate so many of these resources for the purposes of storing and processing signals returned from the vehicle's environment, as well as for subsequently sending processed information downstream to the other computational components of the vehicle. As a more specific example, the limitations of the storage space, computation power, thermal budget, and/or bandwidth can limit how many samples (e.g., sampled data) of detected return pulses from a given detection time period the existing lidar system processors can digitize, store, and transfer.

Accordingly, the present methods and systems can improve the use of available resources while maintaining or increasing the confidence with which the lidar system instruments the environment, especially in environments where there are aerosols or other particles in the field of view, such as from fog, mist, snow, dust, rain, vehicle exhaust, or other agents, all of which can cause spurious returns or other interference to be detected by the lidar system. Such spurious-return-causing agents are also referred to herein as environmental conditions in the context of the present disclosure. The environmental conditions described herein can be weather-related conditions including rain, snow, mist, and fog, and conditions that might not be weather-related, such as dust, exhaust, or mist/fog.

The disclosed methods are described with respect to a range of interest. Herein, a range of interest can refer to an estimated range from the vehicle containing at least a portion of the environmental conditions referred to above. The range of interest can be a close range relative to the vehicle (e.g., between approximately 0-350 meters from the vehicle, or between approximately 50-400 meters from the vehicle) or a long range relative to the vehicle (e.g., distances beyond 350 meters from the vehicle, or beyond 600 meters from the vehicle). Other examples are possible as well.

Consider for instance the following more-particular examples of a lidar system's limited resources. Because it is desired for the lidar system to carry out a sequence of scans in relatively quick succession in order to repeatedly detect a changing environment of the vehicle, the detection time period for each scan in the sequence can be limited (e.g., 1500-3000 nanoseconds), so as to not interfere with subsequent detection times for subsequent light pulses. Further, because environmental conditions such as those described above can generate more samples than desired, such environmental conditions can consume more of the available samples that the lidar system can obtain from the duration of the detection time period. Additionally or alternatively, the lidar system might be limited in terms of how many samples (e.g., sampled data that meet predefined criteria associated with the lidar system, such as a minimum received signal strength) can be stored in memory and/or processed. When spurious returns are present, such as due to environmental conditions, a large portion (e.g., most, or all) of the limited number of samples can be consumed by discrete samples that correspond to light scattered by the environmental conditions. In such instances, only a small portion (e.g., few, or none) of the limited number of samples are left to correspond to discrete samples of light reflected off roadway objects in the vehicle's field of view, which may be more relevant to a use of the lidar or a decision that may be made using lidar data, particularly when such environmental conditions are at close range.

In view of the above, one way in which the present methods and systems improve over existing systems by making improved use of the limited detection time period. In particular, a lidar system can include a lidar device configured to instrument a field of view in a particular direction relative to the vehicle (e.g., in front of the vehicle). The lidar device can be operated to listen during two detection time windows—a first detection time window that starts at approximately the start time of the detection time period, and a second detection time window that starts a predetermined time delay from the start time of the detection time period. As a result, through the first detection time window, the lidar device can detect returned pulses corresponding to objects that are closer to the vehicle. Similarly, through the second detection time window, the lidar device can detect returned pulses corresponding to objects that are farther from the vehicle. For example, the first detection time window can be configured to detect returned pulses within a range of 0 to A meters, such as 0 to 250 meters, 0 to 300 meters, or 0 to 350 meters from the vehicle, and the second detection time window can be configured to detect returned pulses corresponding to objects within a second range that is farther from the vehicle, such as 150 to 500 meters, 200 to 600 meters, 250 to 700 meters, or some other range from the vehicle such as A meters to B meters, or A-x meters to B meters. Thus, less time can be spent instrumenting the portion of the field of view closer to the vehicle, and more time can be spent instrumenting the portion of the field of view farther from the vehicle.

Further, by having the lidar device spend less time instrumenting the portion of the field of view closer to the vehicle, less of the limited number of samples can be from the closer portion, and more of the limited number of samples can be from the portion farther from the vehicle. This can provide an added benefit in situations in which environmental conditions such as fog, mist, rain, dust, or snow, may be causing dense returns at short range from the vehicle, since returned pulses detected during an earlier portion of the detection time period could be more likely to correspond to returns from the fog, mist, rain, dust, or snow. The predetermined time delay can be used to increase the number of samples that correspond to returned pulses from objects beyond the fog, mist, rain, dust, or snow (or within, but at farther distances), so as to improve the confidence with which the environment is instrumented at farther distances from the vehicle.

The relationship between the first and second ranges, and likewise, between the first and second detection time windows, can be adjusted based on the speed of light and expected time of flight of light pulses so as to adjust a degree of overlap (if any) of the first and second ranges and time windows.

A predetermined time delay such as the one described above can also be implemented with lidar devices that include multiple transmit/receive channels arranged to scan respective portions of a field of view. For instance, a lidar device can include a light-emitter device that emits a plurality of light pulses into the field of view. The lidar device can also include a plurality of detectors and a lens that focuses light returned from the field of view for receipt by the plurality of detectors. A first detector of the plurality may be arranged to intercept a first portion of the returned or focused light from a first portion of the field of view that was illuminated by a first light pulse of the plurality of light pulses. Similarly, a second detector may be arranged to intercept a second portion of the returned or focused light from a second portion of the field of view that was illuminated by a second light pulse, and so on. Thus, one or more detectors may be assigned or aligned with a corresponding transmitted light pulse to define a channel of the lidar device.

With this type of lidar device, the predetermined time delay can be implemented on a subset of the channels (e.g., one or two of the channels) such that the corresponding detector(s) for that/those channel(s) starts listening later than the detector(s) on the other channels that start listening at the start time of the detection time period. This type of lidar device might not have the same limitations in terms of detection time period, but might still be limited in terms of how many samples can be stored, and thus the predetermined time delay can provide more samples that correspond to a portion of the field of view farther from the vehicle.

In practice, return pulses can be filtered using a threshold (e.g., an analog or digital threshold), referred to herein as a “filtering threshold” or a “receiver threshold.” That is, the lidar system can filter the waveforms to remove or disregard samples that fall below the threshold, so as to control which samples are processed and which are not. The present methods and systems can also involve dynamically controlling the receiver threshold in order to improve the control of the number of samples that the lidar system records. For example, when the vehicle or self-driving or autonomous system detects fog, mist, snow, rain, dust, or other environmental conditions that cause spurious returns or interference that is present at close range, the lidar system can increase the receiver threshold. As a more specific example, the act of increasing the receiver threshold can involve using a linear ramp filter or other specially-designed filter that filters out samples of a waveform that correspond to closer-range return pulses (or return pulses that are in an estimated area in which the interference is present), thus reducing the number of noisy samples due to interference that are processed and placing more of an emphasis on samples corresponding to areas in which there is less (or no) interference. As a result, the lidar system can maintain a desirable, confident detectability at far range in the field of view.

The present methods and systems involve other techniques for improving the manner in which the lidar system uses available resources. As an example, the lidar system can decrease the sampling rate (e.g., from A GHz to 0.5*A GHz, such as from 1.4 GHz to 0.7 GHz, thereby approximately halving the number of samples for each return pulse). Thus, even if more of the return pulses correspond to interference in the field of view than correspond to objects in the field of view for which detection is more desirable, fewer samples are recorded overall, thereby reducing the processing load on the controller farther downstream in the lidar system or self-driving or autonomous system.

As another example, the lidar system can include, for a light-emitter device, a corresponding primary detector and a corresponding secondary detector, where the secondary detector is optically or electrically attenuated. When listening during the detection time period at close range up to a predefined threshold distance (e.g., 0 to 5 meters, 0 to 10 meters, or 0 to 20 meters), the lidar system can use the secondary detector, and can then switch to using the primary detector beyond the predefined threshold distance. Because the secondary detector is attenuated, return pulses from interference such as fog or dust can consume fewer samples.

Furthermore, a lidar system may have different detector sensitivities (e.g., different respective sensitivities of detectors when receiving signals) based on different areas within the lidar system's field of view. That is, the lidar system may be more sensitive in some areas of the field of view than in others. These differences in sensitivity may be due to various factors, such as the configuration of various optics (e.g., mirrors, lenses, filters, windows, etc.) in the lidar system. Such sensitivity differences can exist in embodiments where the lidar system includes a single detector and in embodiments where the lidar system includes more than one detector. Further, such differences in sensitivity can at times be due to intentional or unintentional differences in the different detectors (e.g., fabrication tolerances) and/or due to other differences (e.g., in gain) in the circuitry used to move signals from the detector(s) to the processor.

In practice, the lidar system may be most sensitive to spurious returns in portions of its field of view that are most sensitive. That is, the lidar system can receive spurious returns when a sufficiently strong atmospheric disturbance (e.g., rain, exhaust, snow, etc.) is present in a portion of the lidar system's field of view in which the lidar system is most sensitive. Accordingly, the present disclosure also enables the lidar system to reduce spurious returns from atmospheric disturbances in portions of the field of view where the lidar system (e.g., where a particular subset of one or more detectors) is most sensitive (e.g., at close range, such as within 10 meters from the vehicle, and/or in a direction straight ahead in front of the vehicle).

Thus, the present disclosure promotes the adjustment of at least the aforementioned return light control parameters (e.g., detection time period, sampling rate, filtering threshold, etc.) based on a detection of a dynamic environmental condition, as well as the adjustment of return light control parameters in non-dynamic conditions, such as when it is desired to adjust the return light control parameters in order to reduce spurious returns from atmospheric disturbances in a part of the lidar system's field of view that is more sensitive.

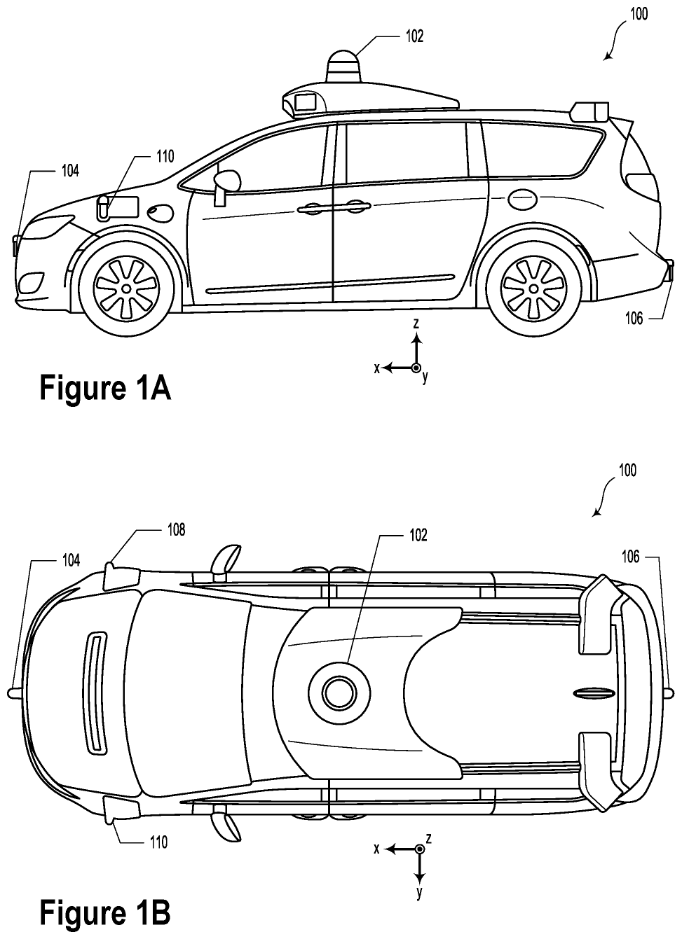

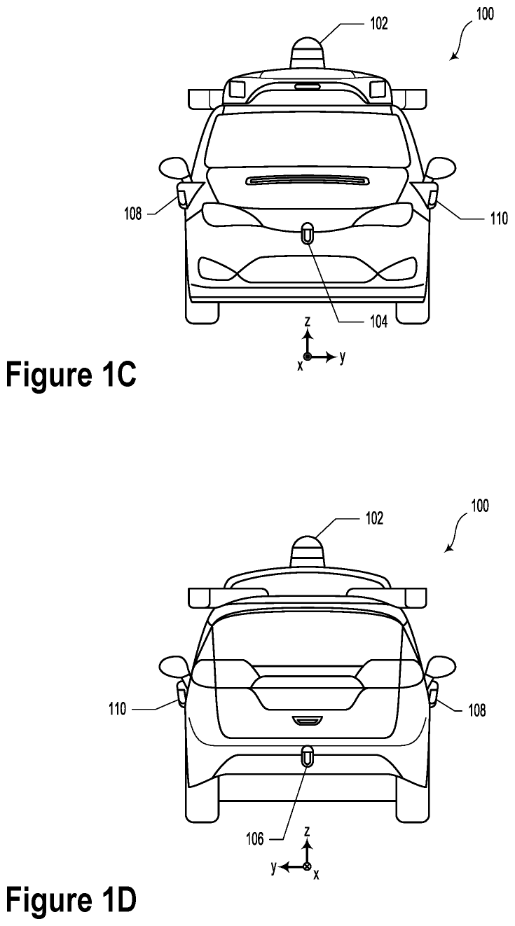

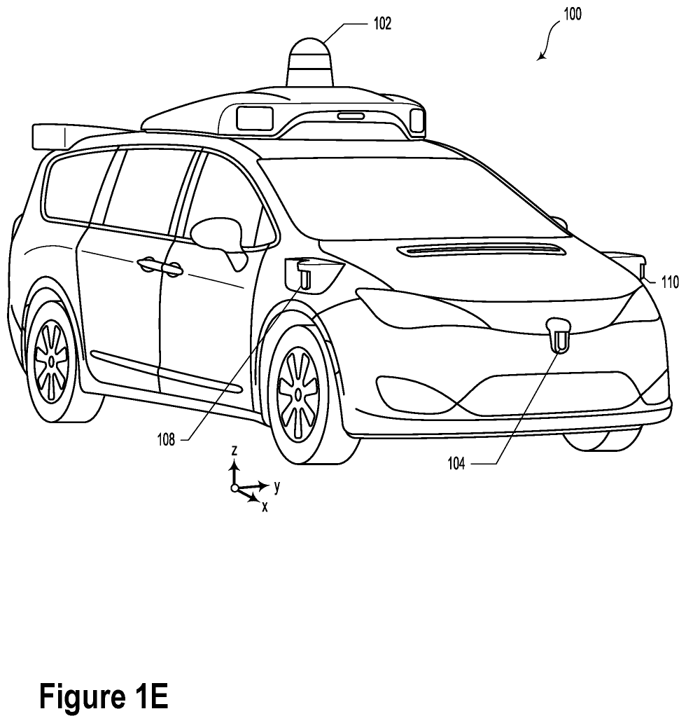

FIGS. 1A, 1B, 1C, 1D, and 1E illustrate a vehicle 100, according to an example embodiment. In some embodiments, the vehicle 100 could be a semi- or fully-autonomous vehicle. While FIGS. 1A, 1B, 1C, 1D, and 1E illustrates vehicle 100 as being an automobile (e.g., a passenger van), it will be understood that vehicle 100 could include another type of autonomous vehicle, robot, or drone that can navigate within its environment using sensors and other information about its environment.

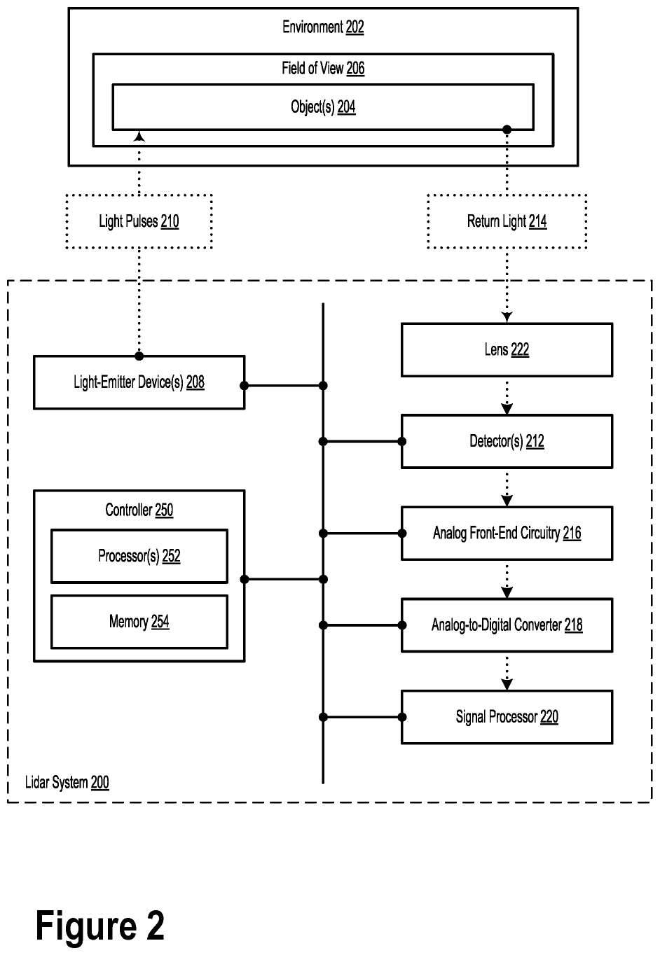

The vehicle 100 may include one or more sensor systems 102, 104, 106, 108, and 110. In some embodiments, sensor systems 102, 104, 106, 108, and 110 could include lidar system(s) 200 as illustrated and described in relation to FIG. 2. In other words, the lidar systems described elsewhere herein could be coupled to the vehicle 100 and/or could be utilized in conjunction with various operations of the vehicle 100. As an example, the lidar system 200 described herein could be utilized in self-driving or other types of navigation, route and speed planning, perception, and/or mapping operations of the vehicle 100.

While the one or more sensor systems 102, 104, 106, 108, and 110 are illustrated on certain locations on vehicle 100, it will be understood that more or fewer sensor systems could be utilized with vehicle 100. Furthermore, the locations of such sensor systems could be adjusted, modified, or otherwise changed as compared to the locations of the sensor systems illustrated in FIGS. 1A, 1B, 1C, 1D, and 1E.

In some embodiments, sensor systems 102, 104, 106, 108, and 110 could include a plurality of light-emitter devices arranged over a range of angles with respect to a given plane (e.g., the x-y plane) and/or arranged so as to emit light toward different directions within an environment of the vehicle 100. For example, one or more of the sensor systems 102, 104, 106, 108, and 110 may be configured to scan about an axis (e.g., the z-axis) perpendicular to the given plane so as to illuminate an environment around the vehicle 100 with light pulses. Based on detecting various aspects of reflected light pulses (e.g., the elapsed time of flight, polarization, intensity, etc.), information about the environment (e.g., point cloud data) may be obtained and/or determined.

In an example embodiment, sensor systems 102, 104, 106, 108, and 110 may be configured to provide respective point cloud information that may relate to physical objects within the environment surrounding the vehicle 100. While vehicle 100 and sensor systems 102, 104, 106, 108, and 110 are illustrated as including certain features, it will be understood that other types of sensor systems are contemplated within the scope of the present disclosure.

Lidar systems with single or multiple light-emitter devices are also contemplated. For example, light pulses emitted by one or more laser sources, e.g., laser diodes, may be controllably directed about an environment of the system. The angle of emission of the light pulses may be adjusted by a scanning device such as, for instance, a mechanical scanning mirror, a rotational motor, mirror, and/or other beam steering mechanism. For example, the scanning devices could rotate or steer in a reciprocating motion about a given axis and/or rotate or steer about a vertical axis. In another embodiment, the light-emitter device may emit light pulses towards a spinning prism mirror, which may cause the light pulses to be emitted into the environment based on an angle of the prism mirror angle when interacting with each light pulse. Additionally or alternatively, scanning optics and/or other types of electro-opto-mechanical devices are possible to scan the light pulses about the environment. While FIGS. 1A-1E illustrate various lidar sensors attached to the vehicle 100, it will be understood that the vehicle 100 could incorporate other types of sensors, such as cameras, radars, etc.

FIG. 2 illustrates a lidar system 200, according to an example embodiment. The lidar system 200 can be configured to provide range data about an environment 202 surrounding the vehicle and one or more objects 204 within the environment 202 and within a field of view 206 of the lidar system 200.

The lidar system 200 includes one or more light-emitter devices 208 configured to emit light pulses 210 into the environment 202 surrounding the vehicle. In some examples, the one or more light-emitter devices 208 can be configured to emit infrared or near-infrared light pulses 210.

The lidar system 200 also includes one or more detectors 212 configured to detect return light 214 (e.g., reflected or scattered light pulses). Interactions of the light pulses 210 with various objects 204 in the environment 202 could result in return light 214 being received by the one or more detectors 212. By measuring the pulse amplitude/intensity, pulse transit time, pulse polarization, and other aspects of the return light 214, the lidar system 200 and/or one or more other perception systems or subsystems associated with the vehicle can provide point cloud data based on objects 204 in the environment 202.

The lidar system 200 also includes analog front-end circuitry 216, an analog-to-digital converter 218, and a signal processor 220. In some examples, the analog front-end circuitry 216 can be included as part of the analog-to-digital converter 218.

As shown, in some examples, the lidar system 200 can also include a lens 222 that focuses return light 214 from the field of view 206 for receipt by the one or more detectors 212, which can include a plurality of detectors. For instance, a first detector of the plurality of detectors 212 may be arranged to intercept a first portion of the returned or focused light from a first portion of the field of view 206 that was illuminated by a first light pulse of the light pulses 210. Similarly, a second detector may be arranged to intercept a second portion of the returned or focused light from a second portion of the field of view that was illuminated by a second light pulse of the light pulses 210, and so on. Thus, the one or more detectors 212 may be assigned or aligned with a corresponding transmitted light pulse to define a channel of the lidar system 200.

In some embodiments, the lidar system 200 can also include a controller 250. In some embodiments, the controller 250 could include at least one of a field-programmable gate array (FPGA) or an application-specific integrated circuit (ASIC). Additionally or alternatively, the controller could include a processor 252 and at least one memory 254. The one or more processors 252 may include a general-purpose processor or a special-purpose processor (e.g., digital signal processors, graphics processor units, etc.). The one or more processors 252 may be configured to execute computer-readable program instructions that are stored in the memory 254. As such, the one or more processors 252 may execute the program instructions to provide at least some of the functionality and operations described herein.

The memory 254 may include, or take the form of, one or more computer-readable storage media that may be read or accessed by the one or more processors 252. The one or more computer-readable storage media can include volatile and/or non-volatile storage components, such as optical, magnetic, organic, or other memory or disc storage, which may be integrated in whole or in part with at least one of the one or more processors 252. In some embodiments, the memory 254 may be implemented using a single physical device (e.g., one optical, magnetic, organic or other memory or disc storage unit), while in other embodiments, the memory 254 can be implemented using two or more physical devices.

As noted, the memory 254 may include computer-readable program instructions that relate to operations of adjusting parameters of the lidar system 200 and causing the lidar system 200 to operate with the adjusted parameters. As such, the memory 254 may include program instructions to perform or facilitate some or all of the operations or functionalities described herein. For example, the memory 254 can include program instructions that, when executed, control one or more components of the lidar system 200, such as the analog front-end circuitry 216, the analog-to-digital converter 218, and the signal processor 220.

The controller 250 shown in FIG. 2 can also represent a controller that can be located outside of the lidar system 200, such as a controller of a perception system of the vehicle, a controller of a lidar system or perception system of another vehicle with which the vehicle is in communication, and/or a controller of a cloud-based computing device (e.g., a server). Other examples are possible as well.

In operation, the lidar system 200 can obtain a sequence of scans of the field of view 206 of the environment 202. For example, in one scan of the sequence, the one or more light-emitter devices 208 can emit the light pulses 210 into the field of view 206 during an emission time period, and then the one or more detectors 212 can listen for the return light 214 during a detection time period that follows the emission time period. Due to reflection or scattering of the light pulses 210 when the light pulses 210 encounter objects (e.g., street signs, other vehicles, etc.) or atmospheric disturbances (e.g., rain, fog, snow, dust, etc.) in the environment 202, at least a portion of the light pulses 210 may be redirected back toward the lidar system 200 as the return light 214 and detected by the one or more detectors 212 during the detection time period. Light pulses that reflect off objects that are closer to the vehicle can take less time to return to the one or more detectors 212, and thus the one or more detectors 212 can detect such light pulses earlier during the detection time period. By contrast, light pulses that reflect off objects that are farther from the vehicle can take more time to return to the one or more detectors 212, and thus the one or more detectors can detect such light pulses later during the detection time period.

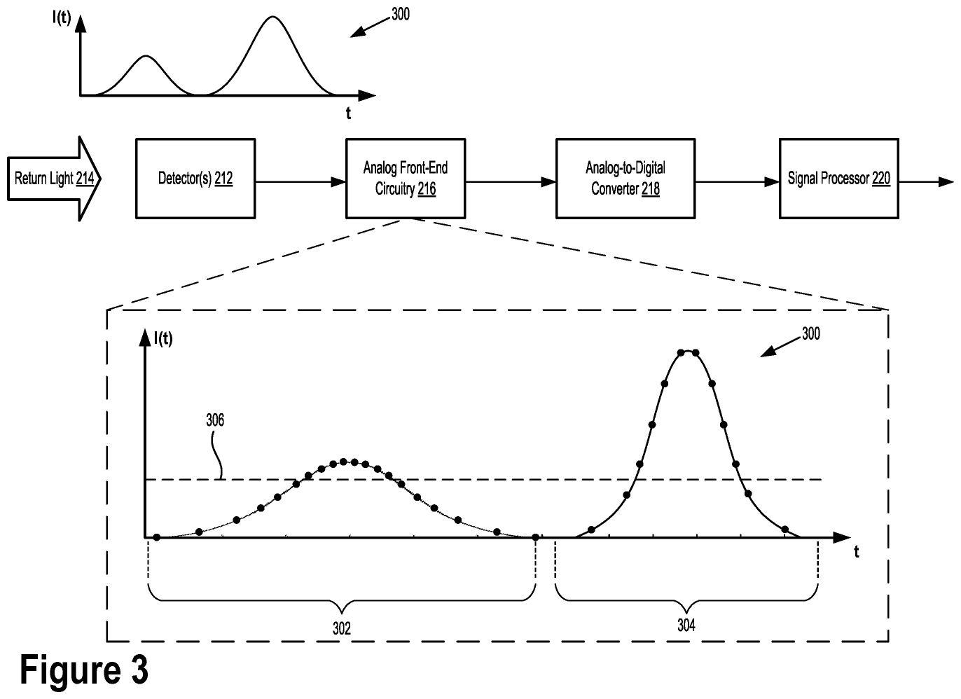

Operation of a subset of the components of the lidar system 200 will now be described in more detail with respect to FIG. 3.

FIG. 3 illustrates a path for signals representing the return light 214, according to an example embodiment. Upon receipt of the return light 214 by way of the one or more detectors 212, the lidar system 200 can measure the intensity of each pulse of the return light 214 and represent the intensity in a waveform that indicates the intensity of the return light 214 over time. An example of such a waveform 300 is shown in FIG. 3, in terms of intensity, I(t) over time, t.

During detection, each such waveform (e.g., waveform 300) can be sampled by a sampling chip, an example of which can be or include the analog front-end circuitry 216 and the analog-to-digital converter 218, where each sample represents a particular return intensity of the waveform at a particular point in time. Thus, distances to each point within the field of view 206 (e.g., within a point cloud corresponding to the field of view 206), and the physical characteristics of those points (e.g., reflectivity, color, etc.), can be represented by a corresponding waveform. For example, the distance to a given point within the field of view 206 can be determined based on a speed of light in air and further based on a time of flight. Thus, from this processing, the lidar system 200 can build a representation of the field of view 206, such as a 3D point cloud.

As a representative example, a first return pulse 302 and a second return pulse 304 are shown as part of waveform 300 in FIG. 3, where the first return pulse 302 has twenty samples and the second return pulse 304 has twelve samples. The samples shown in FIG. 3 are represented by the dots on waveform 300. In some examples, the first return pulse 302, as well as one or more other return pulses (not shown) that precede the first return pulse 302, might correspond to closer-range returns where environmental conditions that cause spurious returns or interference are present. Further, the second return pulse 304, as well as one or more other return pulses (not shown) that follow the second return pulse 304, might correspond to longer-range returns where the environmental conditions that cause spurious returns or interference are not present.

In some examples, due to the analog and digital circuitry in the analog front-end circuitry 216 and the analog-to-digital converter 218, as well as due to bandwidth limitations between the lidar system 200 and one or more other computing devices (e.g., a central computing device of the perception system of the vehicle, or another computing device outside of the lidar system 200 to which the lidar system 200 sends lidar data), the total number of samples that are taken across a set of return pulses can be limited to a predetermined number (e.g., a number selected from a range of 20-50 samples). The total number of samples can be more or less than 20-50 samples, in other examples.

The lidar system 200 can filter a waveform before or after the waveform is digitized, which can remove samples that fall below or above a particular threshold, depending on the threshold used. For example, before the waveform is digitized, the lidar system 200 can filter the waveform using an analog filter. The analog filter can have a variable filtering threshold, such as filtering threshold 306 shown in FIG. 3, which can be set or adjusted by setting or adjusting an input voltage to the analog filter, for instance. More particularly, the analog filter can take the form of a comparator having two inputs, namely, (i) a voltage input that acts as the filtering threshold and (ii) the current waveform that represents the return light (e.g., waveform 300). To set or adjust the filtering threshold in this scenario, a voltage source that feeds the voltage input to the comparator can be set or adjusted (e.g., based on a table or other mapping data that maps each of a plurality of weather conditions to a corresponding voltage). Further, in some cases, the filtering threshold for the analog filter could be static instead of variable. Other techniques for analog filtering could be used as well.

Additionally or alternatively, after the waveform is digitized, the lidar system 200 can filter the waveform using a digital filter. Like the analog filter, the digital filter can have a static or variable filtering threshold that can be set or adjusted in various ways. In an example, a look-up table can be used for filtering the digitized waveform. As a more particular example, the look-up table can specify certain timestamps or intensity values that are each mapped to a corresponding one of the various weather conditions discussed herein. The signal processor 220 can then use the look-up table to filter out portions of the waveform that correspond to the specified timestamps and/or intensity values. In a look-up table embodiment, the filtering threshold can be a particular timestamp below or above which portions of the waveform should be removed, or the filtering threshold can be an intensity below or above which portions of the waveform should be removed. Other techniques for digital filtering are possible as well.

In some examples, sampling of a waveform might not occur unless the analog level of the waveform is above the filtering threshold 306. That is, the lidar system 200 can filter the waveforms to remove or disregard samples that fall below the filtering threshold 306. The filtered and sampled waveforms can then be digitized by the analog-to-digital converter 218 and sent to the signal processor 220, other components of the lidar system 200, and/or other computing devices onboard or remote from the vehicle, for further processing and analysis. For example, digitized signals can be transmitted to a perception system (not shown) of the vehicle, where the perception system is configured to determine a map of the objects 204 within the environment 202 of the lidar system 200.

In some examples, rather than sampling waveforms, the lidar system 200 can include an analog detector. In such examples, although sampling is not used, there can be a limited number of returns that the lidar system 200 can process. Further, such a lidar system 200 might not be able to desirably process returns that are too close together, in which case a small spurious return can prevent the lidar system 200 from detecting another return, behind the small spurious return.

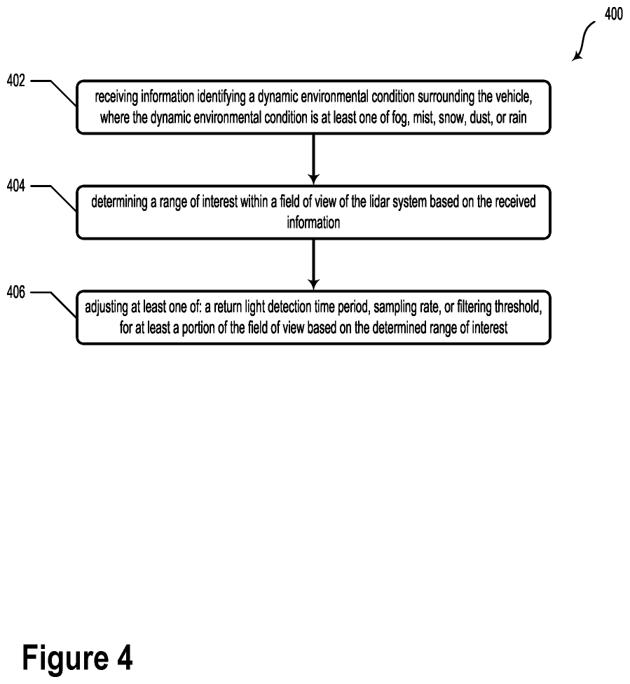

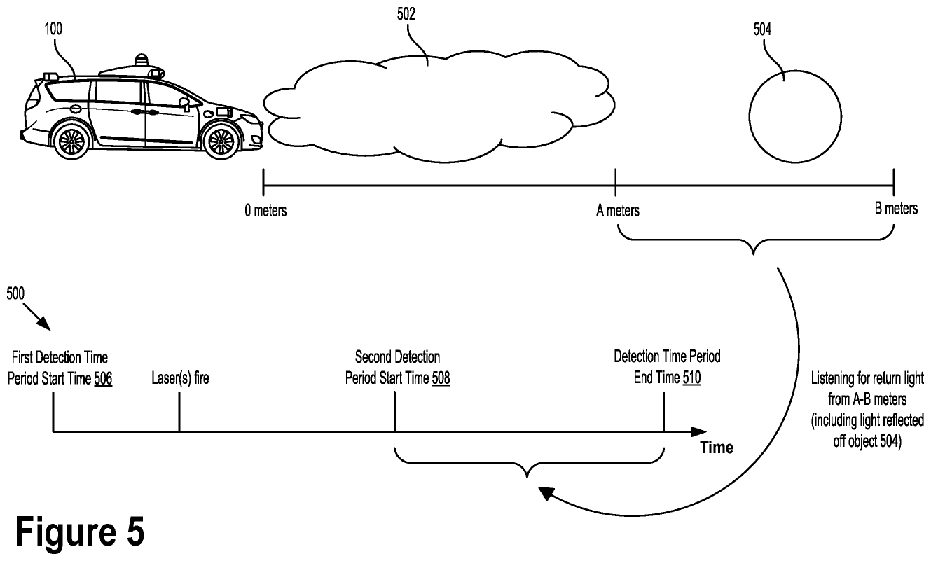

FIG. 4 illustrates a method 400 of operating a lidar system coupled to a vehicle, according to an example embodiment. It will be understood that the method 400 may include fewer or more steps or blocks than those expressly illustrated or otherwise disclosed herein. Furthermore, respective steps or blocks of method 400 may be performed in any order and each step or block may be performed one or more times. In some embodiments, some or all of the blocks or steps of method 400 may relate to elements of lidar system 200 and/or vehicle 100 as illustrated and described in relation to FIGS. 1, 2, and 3, and may also be related to elements of FIGS. 5, 6, and 7.

In some embodiments, controller 250 of the lidar system 200 could be operable to carry out some or all of the blocks of method 400 in conjunction with other elements of lidar system 200, such as laser driver circuits, mechanical actuators, and rotational actuators, among other examples. In some embodiments, method 400 could describe a method of providing and operating a compact lidar system.

The following operations will be described primarily as being performed by controller 250 of the lidar system 200. However, in other embodiments, another computing device can carry out some or all of the operations described herein in addition or alternatively to the controller 250. Examples of such a computing device can include a controller of a cloud-based computing device, a controller of the perception system of the vehicle 100 (e.g., the central computing device of the perception system), or another computing device outside of the lidar system 200.

At block 402, the method 400 includes receiving information identifying an environmental condition surrounding the vehicle. The environmental condition can be or include at least one of fog, mist, snow, dust, or rain, by way of example. The received information can be or include various types of information, including but not limited to lidar data, camera images, radar data, weather forecast data, and/or predetermined map data stored by the controller 250 or other computing device.

In some embodiments, a driver, remote assistant, or passenger of the vehicle 100 might know of the environmental condition (e.g., based on a weather forecast or based on observing a weather condition ahead on the road) and can provide input data identifying the environmental condition. The input data can be provided via a touchscreen GUI onboard the vehicle, for instance. Additionally or alternatively, the input data can be provided via a GUI of a software application that is associated with the vehicle and installed on a smartphone or other computing device of the driver, remote assistant, or passenger.

In some embodiments, the controller 250 can receive the information from one or more sensors coupled to the vehicle 100, such as sensor systems 102, 104, 106, 108, and/or 110, any of which could be a lidar system, radar system, camera system, or other type of system with other types of sensors.

Additionally or alternatively, the controller 250 can receive the information from one or more of such sensors or sensor systems that are coupled to a different vehicle, such as a vehicle nearby on the road or a vehicle that has recently (e.g., within a few minutes or less) travelled through the environmental condition.

Additionally or alternatively, the controller 250 can receive the information from a weather station server or other type of server, such as a social media server or a remote server that is in communication with a fleet of vehicles that includes vehicle 100. The weather station server can be a weather station server that is local to a particular location of the vehicle 100—that is, a weather station server that is dedicated to the particular location and configured to acquire weather data corresponding to the particular location and transmit the weather data to one or more vehicle systems. The particular location can be dynamic (e.g., the vehicle's current location along the route of travel) or static (e.g., the vehicle's destination or a location along the way to the destination). Furthermore, the location can be a circular region having a particular radius and centered on a particular landmark (e.g., a circular region having an 8 kilometer radius and centered on a city center of a city). Other boundaries of the region are possible as well, such as a city and its boundaries denoted on a predetermined map.

In some embodiments, the weather station server can be a global weather station server that is configured to acquire weather data corresponding to multiple locations, such as an entire state, county, country, etc. The global weather station server can also operate as a server configured to collect weather data from a plurality of local weather station servers and transmit the collected weather data to one or more vehicle systems. In some embodiments, the weather station server can be configured to estimate weather conditions in various ways and include varying types of information in the weather data. For example, the weather station server can estimate weather conditions in the form of fog, mist, snow, dust, and/or rain, cloud, fog, and mist droplet distribution, density, and diameter, and/or other forms. The act of such a weather condition estimation might involve the weather station server (or the vehicle 100, or another vehicle) monitoring and analyzing an indication of a fog, mist, dust, rain, etc. quality. Other example functionality of local or global weather station servers is possible as well.

At block 404, the method 400 includes determining a range of interest within a field of view of the lidar system based on the received information.

As previously mentioned, the range of interest can be a close range relative to the vehicle (e.g., between approximately 0 to 350 meters from the vehicle, or between approximately 50 to 400 meters from the vehicle) or a long range relative to the vehicle (e.g., distances beyond 350 meters from the vehicle, or beyond 600 meters from the vehicle). In some examples, the range of interest can be or include the estimated range at which environmental conditions that cause spurious returns or other interference are present in the environment 202 of the vehicle 100. In alternative examples, the range of interest can be or include the estimated range at which no environmental conditions that cause spurious returns or other interference are present. In additional examples, the controller 250 can determine the range of interest to be a range in which the environmental condition is known to be present, plus or minus a buffer distance (e.g., 50 meters) that may or might not include the environmental condition.

In some embodiments, the received information may additionally identify the range of interest, in which case the controller 250 can determine the range of interest to be the range of interest identified in the received information. For example, the controller 250 can receive the information from a server configured to communicate with and control a fleet of vehicles including vehicle 100. In such an example, the server can decide that, in view of the environmental condition(s) surrounding at least the vehicle 100 (and perhaps additionally one or more other vehicles in the vicinity), the range of interest should be a particular range. As another example, the controller 250 can receive the information from a weather station and determine based on the received information that the range of interest should be a particular range. Other examples are possible as well.

In some embodiments, the lidar system 200, another lidar system, a radar system, and/or a camera system of the vehicle 100 can be configured to analyze lidar data, radar data, and/or camera images to calculate range data about the environment 202, and such range data can include the range of interest. For instance, the perception system of the vehicle 100 can determine based on radar data received from a radar system that there is dust present in a region approximately 0 to 350 meters to the front of the vehicle 100 and approximately 100 meters to the sides of the vehicle 100.

At block 406, the method 400 includes adjusting at least one return light control parameter for at least a portion of the field of view based on the determined range of interest. Examples of the at least one return light control parameter can include a return light detection time period, sampling rate, and/or filtering threshold.

In some embodiments, the controller 250 can adjust the return light detection time period by delaying a start time of the return light detection time period.

FIG. 5 illustrates an example timing diagram 500 depicting how the return light detection time period can be adjusted for a subset of the one or more detectors 212 to improve the detection of longer-range returns with respect to the vehicle 100 and lidar system 200, such as returns corresponding to object 504. For example, the vehicle 100 might approach environmental condition 502, such as fog, mist, snow, dust, or rain. The estimated range at which the environmental condition 502 is present in FIG. 5—namely, approximately 0 meters in front of the vehicle 100 to approximately 350 meters in front of the vehicle 100—can be the range of interest.

In practice, the one or more detectors 212 might be configured by default to begin listening at the first detection time period start time 506. In accordance with the disclosed methods, the detection time period can be adjusted for a subset of the one or more detectors 212, such as by having the subset of detectors begin listening at a second detection time period start time 508 that is a predetermined time delay from the first detection time period start time 506. Thus, one subset of detectors can listen during a first detection time window that starts at approximately the first detection time period start time 506 and ends at approximately the detection time period end time 510, and the subset of detectors for which the detection time period is adjusted can listen during a second detection time window that starts approximately the second detection time period start time 508 and ends at approximately the detection time period end time 510. However, there may be some embodiments in which two different subsets of detectors can be configured such that the first detection time window for one subset of detectors has a different detection time period end time than another subset of detectors.

As an example, the predetermined time delay can be selected so that, during the detection time period beginning at the second detection time period start time 508 and ending at the detection time period end time 510, return light is more likely to inform the vehicle system about objects within a longer range (e.g., the range of 250 to 600 meters, 300 to 650 meters, or 350 to 700 meters, or some other range A meters to B meters from the vehicle 100), such as object 504. In other examples, the predetermined time delay can be selected to facilitate detection of return light from other distances from the vehicle 100.

As a result, the subset of detectors can spend less time (or no time) listening for closer-range returns and more time listening for longer-range returns. This can in turn result in less of the limited total number of samples being consumed by closer-range returns, such as dense returns due to the environmental condition 502, and can result in more of the limited total number of samples being consumed by longer-range returns beyond the environmental condition 502, such as returns from object 504.

In some embodiments, the controller 250 can adjust the relationship between the first and second detection time windows based on the speed of light and expected time of flight of light pulses so as to adjust a degree of overlap (if any) of the first and second detection time windows.

In some examples, the subset of detectors for which the detection time period is adjusted can be a subset of detectors of a single lidar device, such that each detector of the subset of detectors correspond to the same one or more light-emitter devices 208.

In other examples, the vehicle 100 can include at least two lidar devices and the subset of detectors can be one or more detectors of one of the two lidar devices. As a more specific example, the vehicle 100 can include a first lidar device having a first light-emitter device and a first detector, and can also include a second lidar device having a second light-emitter device and a second detector. The first lidar device can be mounted to a first location on the vehicle 100, such as on a left side of the vehicle, and the second lidar device can be mounted to a second location on the vehicle 100, such as on a right side of the vehicle 100. In this arrangement, the detection time period can be adjusted for the first lidar device such that the first lidar device listens for returns corresponding to closer-range objects (e.g., within a first range from the vehicle, such as 0 to 350 meters from the vehicle), and the second lidar device can listen for returns corresponding to farther-range objects (e.g., within a second range from the vehicle, such as 150 to 500 meters from the vehicle). As such, instead of the controller 250 obtaining potentially-redundant returns at shorter ranges from instrumenting overlapping portions of the field of view (e.g., so as to have double resolution within a particular volume from the vehicle), the two lidar devices can be more complementary to each other such that more longer-range returns can be obtained. In some instances, the first and second ranges can also be selected to have little to no overlap (e.g., the first range being 0 to 350 meters and the second range being 350 to 600 meters, or the first range being 0 to 350 meters and the second range being 348 to 600 meters). Other examples are possible as well, including other example ranges.

In some embodiments, the one or more detectors 212 can include multiple detectors, and lens 222 can focus return light 214 from the field of view 206 for receipt by the multiple detectors. For instance, a first detector can be arranged to intercept a first portion of the focused light from a first portion of the field of view 206 that was illuminated by a first light pulse of the light pulses 210, a second detector can be arranged to intercept a second portion of the focused light from a second portion of the field of view 206 that was illuminated by a second light pulse of the light pulses 210, a third detector can be arranged to intercept a third portion of the focused light from a third portion of the field of view 206 that was illuminated by a third light pulse of the light pulses 210, and a fourth detector can be arranged to intercept a fourth portion of the focused light from a fourth portion of the field of view 206 that was illuminated by a fourth light pulse of the light pulses 210. Each such detector can be assigned or aligned with a corresponding one of the transmitted light pulses 210 to define a respective channel.

In such embodiments, the predetermined time delay described above can be implemented on a subset of the channels (e.g., one or two of the channels) such that the corresponding detector(s) for that/those channel(s) starts listening later than the detector(s) on the other channels that start listening at the start time of the detection time period.

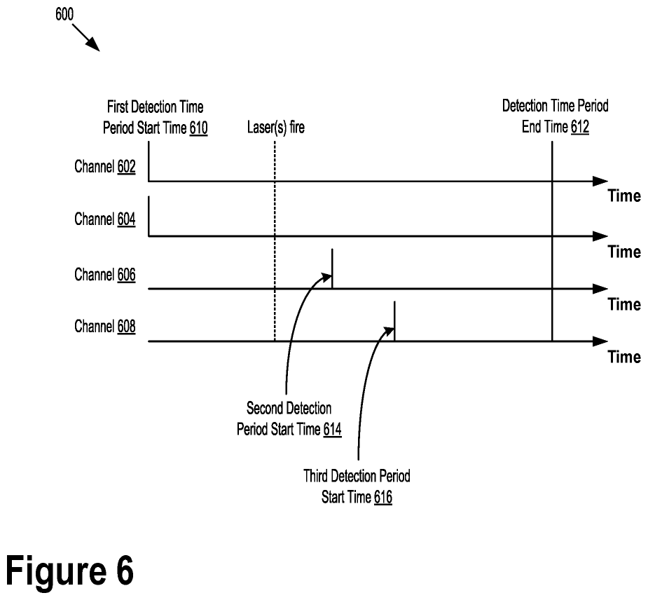

As an illustrative example, FIG. 6 is a timing diagram 600 depicting the timing for four channels—channel 602, channel 604, channel 606, and channel 608, each of which corresponds to a respective detector (not shown). In practice, each of the four detectors might be configured by default to begin listening at the first detection time period start time 610 and end listening at a detection time period end time 612. In accordance with the disclosed methods, the detection time period can be adjusted for two of the detectors—namely, the detectors corresponding to channel 606 and channel 608—such that each of the two detectors begin listening later. As shown, for instance, the detector corresponding to channel 606 can begin listening at a second detection period start time 614 and the detector corresponding to channel 608 can begin listening at a third detection period start time 616.

In other examples, the timing of the four channels can be different than those shown in FIG. 6. For example, channel 602 and channel 604 might have different detection period start times. Other examples are possible as well.

In some embodiments, the lidar system can include a first detector and a second detector, and the first detector can be attenuated. For instance, the first detector and the second detector can both be the same type of detector (e.g., a silicon photomultiplier (SiPM) detector), and the input optical signal of the first detector can be optically attenuated by a particular degree (e.g., by 10-20 decibels (dB)). The first detector could include a non-50-50 beam splitter to accomplish the aforementioned attenuation, for instance. Alternatively, the first detector could include a neutral-density filter. In another example, the two detectors can be different types of detectors/technologies. For instance, the first detector can be a SiPM with high sensitivity, and the second detector can be a linear avalanche photodiode (APD) or a PIN diode that has more dynamic range. As yet another example, the first and second detectors can be distinguished in that the second detector acts as a secondary detector that, instead of receiving the return light from the environment, receives light that has reflected off of the first detector, so as to recycle light that otherwise might have not been used.

In embodiments where one of the two detectors is attenuated, the controller 250 can adjust the return light detection period by dividing the return light detection time period into a first detection time period and a second detection time period. Specifically, during the first detection time period, the attenuated first detector can detect shorter-range return light, and during the second detection time period, the second detector can detect longer-range return light. Thus, the controller 250 can first use returns detected by the attenuated first detector and then, beginning at a certain point in time during the return light detection time period and at a certain range, the controller 250 can switch to using returns detected by the second detector. As an example, the attenuated first detector listens for returns from a range of 0 to 5 meters or some other range A meters to B meters from the vehicle 100, and then the second detector listens for returns beyond 5 meters or B meters, or for returns beyond 4 meters, B minus 1 meters (B-1 meters), or some other range that provides overlap with the range for the first detector. The controller 250 can then combine returns from both time periods and ranges. In some examples, the return light detection period can be “divided” such that the first detection time period at least partially overlaps with the second detection time period. For instance, the first detector might listen during part or an entirety of the second detection time period.

In other embodiments, such as those in which one of two detectors is attenuated (e.g., optically attenuated), the controller 250 can adjust an attenuation of the attenuated detector.

In some embodiments, the controller 250 can adjust the sampling rate by reducing the sampling rate, so as to reduce the number of samples taken for each return pulse. For example, the controller 250 can reduce the sampling rate from 1.4 GHz to 0.7 GHz, or from some other frequency A GHz to 0.5*A GHz, which can halve the number of samples. Other reductions or adjustments to the sampling rate are possible as well, and the sampling rate can be selected from another range of frequencies, such as frequencies within a MHz range.

Furthermore, in some embodiments, the controller 250 can adjust the filtering threshold 306 by increasing the filtering threshold 306. Increasing the filtering threshold 306 can filter out samples of waveform 300 that correspond to closer-range return pulses (or return pulses that are in an estimated area in which the environmental conditions that cause spurious returns or interference are present), such as return pulses from the range of interest in which the environmental conditions that cause spurious returns or other interference are present. As a result, for example, the number of noisy close-range samples due to spurious returns or interference that are processed can be reduced and there can be more of an emphasis placed on samples corresponding to areas in which there are less (or no) environmental conditions that cause spurious returns or interference. The filtering threshold 306 can be increased or otherwise adjusted to be a particular level for an entirety of the duration of a single shot (e.g., one pulse from one light-emitter), or can be dynamically adjusted over the duration of a single shot (e.g., increased to a first threshold for a first, beginning portion of the shot, and then decreased to a second threshold for a remainder of the shot).

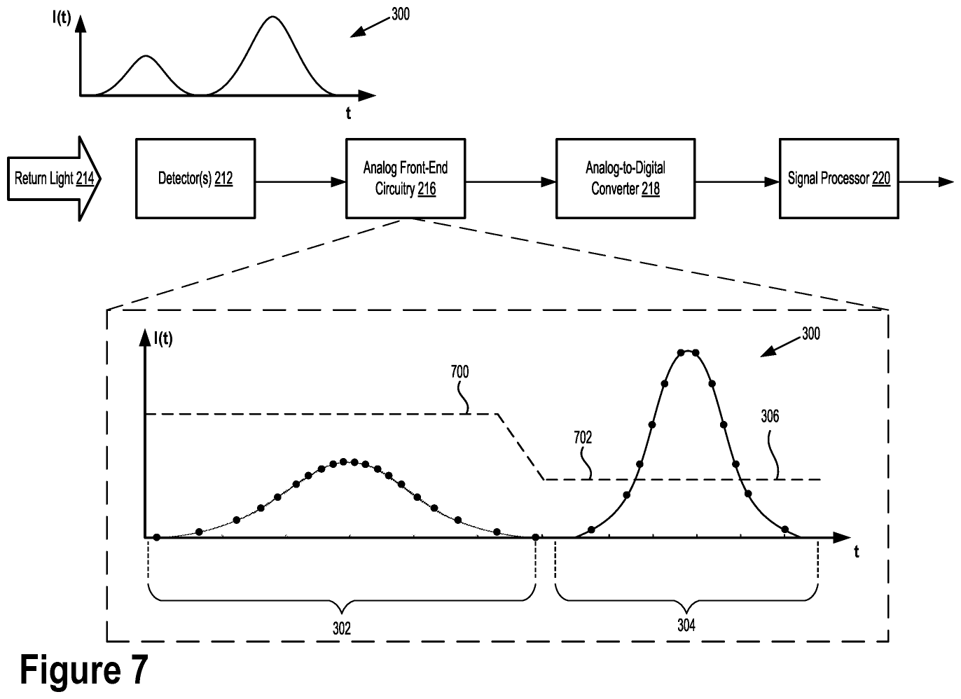

As an illustrative example, FIG. 7 depicts a situation in which the controller 250 has increased the filtering threshold 306 (which was previously shown in FIG. 3) in response to detecting fog, mist, snow, rain, dust, or other atmospheric disturbances that are present at close range to the vehicle 100. More particularly, FIG. 7 depicts a situation in which the filtering threshold 306 can be adjusted by dynamically increasing the filtering threshold 306 to filter some return pulses, and then dynamically lowering the filtering threshold 306 so as to not as strictly filter other return pulses.

As shown in FIG. 7, the filtering threshold 306 can be dynamically increased to filter the first return pulse 302 (which might correspond to closer-range returns where environmental conditions that cause spurious returns or interference are present), but can then be dynamically lowered so as to not as strictly filter the second return pulse 304 (which might correspond to longer-range returns where the environmental conditions that cause spurious returns or interference are not present). As a result, the disclosed methods can advantageously provide additional control over which samples are processed and which samples are not processed, and can favor processing of samples that are less likely to correspond to closer-range returns where interference is present and return light intensity might be higher. As further shown in FIG. 7, the filtering threshold 306 can have a linear ramp shape that begins at a first filtering threshold 700 for closer-range returns and then decreases to a second filtering threshold 702 for farther-range returns. Other shapes, both linear and nonlinear, for the filtering threshold 306 are possible as well, such as a stepped or exponential decay function. For instance, the filtering threshold 306 can be nonlinear, beginning with a sharp, curved ramp-up for closer-range returns and following with a steady, curved ramp-down for farther-range returns.

In some examples, the filtering threshold 306 can be lower at first, then ramped up when the gain of the system peaks, and then brought back down. In other examples, the filtering threshold 306 can be continuously modulated such that it is adjusted for every sample that is acquired. In further examples, having a lower filtering threshold 306 can be useful for particular types of lidar devices such as monostatic lidar devices where self-reflections might induce a loss of sensitivity for a short period of time following the emission of a pulse.

In examples where the lidar system 200 includes an analog detector and is limited in the number of returns that can be processed, the filtering threshold 306 can be adjusted for that detector to filter out small spurious returns that might otherwise prevent the lidar system 200 from detecting and processing larger returns behind the small spurious return.

As an alternative to adjusting the filtering threshold 306, the controller 250 can adjust a bias voltage associated with a particular detector or subset of detectors. Doing so can advantageously reduce sensitivity in a manner similar to the above-described effect from reducing the filtering threshold 306. Further, adjusting the bias voltage can have the additional benefit of avoiding depletion of a SiPM or geiger mode APD by making such a detector less sensitive to photons during a time window where the bias voltage is reduced.

In some situations, it can be desirable to adjust only a subset of the parameters described above. For example, if an object is likely to be very close to the vehicle 100 (e.g., a few meters away), the controller 250 can increase the filtering threshold 306 for close-range returns, but might not adjust the detection time period.

In some situations, the controller 250 can be configured to take other factors into account when making adjustments to parameters for detections made in certain directions. For example, the controller 250 can take into account objects, road conditions, or other information that the controller 250 is expecting to see as it travels. As a more specific example, predetermined map data or other data might indicate to the controller 250 that there is an exit ramp on a highway coming up, in which case adjustments might be made to parameters in a direction of the exit ramp, so that the vehicle 100 can see through any fog, dust, or other atmospheric disturbances present that might occlude the lidar system's 200 instrumentation of the portion of the field of view 206 that includes where the exit ramp will be. As another specific example, when the vehicle 100 is planning on making a left-hand turn, the controller 250 can be configured to responsively adjust one or more parameters for detectors on the left side of the vehicle 100 so as to promote acquiring more close-range returns in that direction. Other examples are possible as well.

In some embodiments, such as those in which application-specific integrated circuits provide limitations that in turn limit how the lidar system 200 processes returns, a single detector can be connected to multiple receiver electronics chains, and one or more of the return light control parameters described herein can be adjusted for the single detector.

In some situations, one or more of the return light control parameter adjustments described above may result in artifacts being present in lidar data, which can make the accuracy of the resulting point cloud less than desirable. For instance, variance in the filtering threshold can chop off the leading or trailing edge of a pulse, or otherwise make the pulse appear lower, which can in turn interfere with how the pulse is processed. In another instance, with different overlapping detection time windows, the start of a given pulse might be seen on a secondary detector and the end of the pulse might be seen on a primary detector, in which case it may be desirable for the lidar system to stitch the pulse back together and account for the different sensitivities to obtain accurate range and intensity on the pulse.

As noted above, the lidar system can receive spurious returns when a sufficiently strong atmospheric disturbance (e.g., rain, exhaust, snow, etc.) is present in a portion of the lidar system's field of view in which the lidar system is most sensitive. Thus, in some embodiments, the controller 250 can receive information identifying an environmental condition surrounding the vehicle and can determine that the environmental condition is present in a portion of the lidar system's field of view in which one or more detectors of the lidar system have a sensitivity level that exceeds a predefined threshold sensitivity. In response to determining that the environmental condition is present in the portion of the lidar system's field of view in which the at least one of the detectors of the lidar system have a sensitivity level that exceeds the predefined threshold sensitivity, the controller 250 can adjust at least one of the return light control parameters described above for the one or more detectors. The manner in which the at least one of the return light control parameters are adjusted can be the same as or similar to the manners described above.

The arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A method of operating a lidar system coupled to a vehicle, the method comprising:
receiving information identifying an environmental condition surrounding the vehicle;
determining a range of interest within a field of view of the lidar system based on the received information; and
adjusting at least one return light control parameter for at least a portion of the field of view based on the determined range of interest.

2. The method of claim 1, wherein receiving the information identifying the environmental condition surrounding the vehicle comprises receiving information identifying at least one of fog, mist, snow, dust, or rain surrounding the vehicle.

3. The method of claim 1, wherein the at least one return light control parameter comprises at least one of: a return light detection time period, a return light sampling rate, or a return light filtering threshold.

4. The method of claim 1, wherein adjusting the at least one return light control parameter comprises:
adjusting a return light detection time period for a subset of detectors of the lidar system.

5. The method of claim 4, wherein adjusting the return light detection time period for a subset of detectors of the lidar system comprises:
delaying a start time of the return light detection time period.

6. The method of claim 1, wherein adjusting the at least one return light control parameter comprises:
reducing a return light sampling rate.

7. The method of claim 1, wherein adjusting the at least one return light control parameter comprises:
increasing a return light filtering threshold.

8. The method of claim 1, wherein the lidar system comprises a first detector and a second detector, wherein the first detector is attenuated, and wherein adjusting the at least one return light control parameter comprises:
adjusting a return light detection period by dividing the return light detection time period into a first detection time period during which the first detector detects shorter-range return light and a second detection time period during which the second detector detects longer-range return light.

9. The method of claim 1, wherein receiving the information comprises receiving the information from one or more sensors coupled to the vehicle.

10. The method of claim 1, wherein receiving the information comprises receiving the information from one or more sensors coupled to a different vehicle.

11. The method of claim 1, wherein receiving the information comprises receiving the information from a server.

12. The method of claim 1, wherein the received information further identifies the range of interest, and
wherein determining the range of interest comprises determining the range of interest to be the range of interest identified in the received information.

13. A computing device comprising:
a controller having at least one processor and at least one memory, wherein the at least one processor is configured to execute program instructions stored in the at least one memory so as to carry out operations, the operations comprising:
receiving information identifying an environmental condition surrounding a vehicle, wherein a lidar system is coupled to the vehicle;
determining a range of interest within a field of view of the lidar system based on the received information; and
adjusting at least one return light control parameter for at least a portion of the field of view based on the determined range of interest.

14. The computing device of claim 13, wherein the at least one return light control parameter comprises at least one of: a return light detection time period, a return light sampling rate, or a return light filtering threshold.

15. The computing device of claim 13, wherein adjusting the at least one return light control parameter comprises:
adjusting a return light detection time period for a subset of detectors of the lidar system.

16. The computing device of claim 15, wherein adjusting the return light detection time period for a subset of detectors of the lidar system comprises:
delaying a start time of the return light detection time period.

16. The computing device of claim 13, wherein adjusting the at least one return light control parameter comprises:
reducing a return light sampling rate.

17. The computing device of claim 13, wherein adjusting the at least one return light control parameter comprises:
increasing a return light filtering threshold.

18. The computing device of claim 11, wherein the lidar system comprises a first detector and a second detector, wherein the first detector is attenuated, and wherein adjusting the at least one return light control parameter comprises:
adjusting a return light detection period by dividing the return light detection time period into a first detection time period during which the first detector detects shorter-range return light and a second detection time period during which the second detector detects longer-range return light.

19. The computing device of claim 13, wherein the controller comprises a cloud-based computing device.

20. The computing device of claim 13, wherein the controller comprises a perception system of the vehicle.

21. The computing device of claim 13, wherein the controller comprises a controller of the lidar system.

22. A lidar system coupled to a vehicle, the lidar system comprising:
one or more light-emitter devices configured to emit light into a field of view of the lidar system;
one or more detectors configured to detect returned light; and
a controller having at least one processor and at least one memory, wherein the at least one processor is configured to execute program instructions stored in the at least one memory so as to carry out operations, the operations comprising:
receiving information identifying an environmental condition surrounding the vehicle;
determining a range of interest within a field of view of the lidar system based on the received information; and
adjusting at least one return light control parameter for at least a portion of the field of view based on the determined range of interest.

21. The lidar system of claim 20, wherein adjusting at least one of: a return light detection time period, sampling rate, or filtering threshold comprises:
adjusting a return light detection time period for a subset of detectors of the lidar system.

22. The lidar system of claim 21, wherein adjusting a return light detection time period for a subset of detectors of the lidar system comprises:
delaying a start time of the return light detection time period.

23. The lidar system of claim 20, wherein adjusting at least one of: a return light detection time period, sampling rate, or filtering threshold comprises:
reducing the sampling rate.

24. The lidar system of claim 20, wherein adjusting at least one of: a return light detection time period, sampling rate, or filtering threshold comprises:
increasing the filtering threshold.

25. The lidar system of claim 20, wherein the lidar system comprises a first detector and a second detector, wherein the first detector is attenuated, and wherein adjusting at least one of: a return light detection time period, sampling rate, or filtering threshold comprises:
adjusting the return light detection period by dividing the return light detection time period into a first detection time period during which the first detector detects shorter-range return light and a second detection time period during which the second detector detects longer-range return light.

26. A vehicle comprising:
a lidar system comprising:
one or more light-emitter devices configured to emit light into a field of view of the lidar system;
one or more detectors configured to detect returned light; and
a controller having at least one processor and at least one memory, wherein the at least one processor is configured to execute program instructions stored in the at least one memory so as to carry out operations, the operations comprising:
receiving information identifying an environmental condition surrounding the vehicle;
determining a range of interest within a field of view of the lidar system based on the received information; and
adjusting at least one return light control parameter for at least a portion of the field of view based on the determined range of interest.

27. The vehicle of claim 26, wherein adjusting at least one of: a return light detection time period, sampling rate, or filtering threshold comprises:
adjusting a return light detection time period for a subset of detectors of the lidar system.

28. The vehicle of claim 27, wherein adjusting a return light detection time period for a subset of detectors of the lidar system comprises:
delaying a start time of the return light detection time period.

29. The vehicle of claim 26, wherein adjusting at least one of: a return light detection time period, sampling rate, or filtering threshold comprises:
reducing the sampling rate.

30. The vehicle of claim 26, wherein adjusting at least one of: a return light detection time period, sampling rate, or filtering threshold comprises:
increasing the filtering threshold.

31. The vehicle of claim 26, wherein the lidar system comprises a first detector and a second detector, wherein the first detector is attenuated, and wherein adjusting at least one of: a return light detection time period, sampling rate, or filtering threshold comprises:
adjusting the return light detection period by dividing the return light detection time period into a first detection time period during which the first detector detects shorter-range return light and a second detection time period during which the second detector detects longer-range return light.
